(19) United States
(12) Patent Application Publication
(10) Pub. No.: US 2013/0144617 A1
(43) Pub. Date: Jun. 6, 2013

(54) BACKGROUND NOISE CANCELLING DEVICE AND METHOD

(71) Applicant: Masahide Murakami, Tokyo (JP)

(72) Inventor: Masahide Murakami, Tokyo (JP)

(73) Assignee: NEC CORPORATION, Tokyo (JP)

(21) Appl. No.: 13/640,926

(22) PCT Filed: Apr. 8, 2011
(86) PCT No.: PCT/JP2011/059326

§ 371 Date: Oct. 12, 2012

(30) Foreign Application Priority Data
Apr. 13, 2010 (JP) 2010-091864

(51) Int. Cl. G10L 21/02

(52) U.S. Cl. CPC G10L 21/02
USPC 704/226

(57) ABSTRACT

A background noise cancelling device for removing a background noise from an input signal in which the background noise is mixed in a voice signal to produce an output signal includes: storage a unit for preliminarily storing a predictable background noise, which is the background noise, as a stored background noise in a state in which a synchronization signal is superimposed on the predictable background noise; an estimation unit for reading the stored background noise from the storage unit and for correlating the read stored background noise and the input signal to establish synchronization by using the synchronization signal and to produce a predicted noise; and a subtracting unit for removing the predicted noise from the input signal to produce the voice signal obtained as a result of the removal.

### TECHNICAL FIELD

This invention relates to a voice processing technology, and more particularly, to a background noise cancelling device and method for removing a background noise.

### BACKGROUND ART

In a conventional exchange, there has been known a technology of processing an echo noise by an echo canceller or the like. In other words, the conventional exchange has a function of removing an echo from a downlink voice signal from another network.

However, in the exchange, it has been impossible to process a background noise that was present at the time when the voice signal was input to a network. In other words, the conventional exchange does not have a function of removing the background noise from an uplink signal. This is because, unlike an echo canceller that uses the uplink signal for echo prediction, there is no means for predicting the background noise of the uplink signal.

Due to a difference among terminals connected to the exchange in terms of environments in which the terminals exist, it is impossible in principle to remove all background noises. However, of the background noises, background noises that are easy to predict, such as an announcement over a building public address (PA) system and a public time signal, may be removed. The announcement over the building PA system that is heard as the background noise may be larger than the voice of the person on the phone. Therefore, in order to improve sound quality, it is desired to remove the background noise. In particular, information heard in the announcement over the building PA system may be confidential information, and hence removing the background noise is desired in terms of maintaining confidentiality as well as in terms of the sound quality of the background noise.

There have been known the following methods of suppressing or removing a background noise in an uplink voice signal. A first method is a method of suppressing mixing of a background noise by using a highly directional microphone on the terminal side. A second method is a method of removing a background noise by arraying microphones and applying an arithmetic operation to a plurality of microphone inputs. A third method is a method of removing a background noise by using an active noise canceller.

All of the above-mentioned first to third methods require special software (SW)/hardware (HW), and existing terminals cannot enjoy the benefits of the methods. Therefore, although there are methods of removing a background noise on the terminal side, processing on the network side is required in order to improve the sound quality of the existing terminals.

Mixing of the background noise may cause the following effects:

Sounds other than the voice of the person on the phone are mixed, and hence the sound quality is deteriorated;

When confidential information is heard in the announcement over the building PA system or the like, the information may be leaked; and

There is a possibility of information leakage, such as identification of the location of the person on the phone by the announcement over the building PA system or the like.

On the other hand, there have also been known various prior art documents on removing a background noise.

For example, Japanese Unexamined Patent Application Publication (JP-A) No. Hei 8-130513 (corresponding to U.S. Pat. No. 5,717,724) (hereinafter, referred to as “Patent Document 1”) discloses a technology capable of preventing the effects of a noise and of performing encoding processing with high quality in encoding a signal in which a noise is superimposed on a voice. The encoding system disclosed in Patent Literature 1 includes noise superimposed part detecting means, inverse filtering means, noise removing means, pitch cycle detecting means, and voice encoding means. The noise superimposed part detecting means discriminates a noise superimposed part in which a noise is superimposed on the voice. The inverse filtering means computes a linear prediction factor obtained by linear-prediction-analyzing the noise superimposed part, and produces a prediction residue signal. The noise removing means removes the noise part from the prediction residue signal. The pitch cycle detecting means computes an auto-correlation function of the residue signal output from the noise removing means, and detects a pitch cycle when the auto-correlation function has the maximum value. The voice encoding means encodes a waveform pattern in the noise superimposed part in accordance with the pitch cycle detected by the pitch cycle detecting means.

Patent Document 1 merely discloses the encoding system for predicting the background noise and for encoding the waveform pattern in the noise superimposed part in accordance with the pitch cycle.

Japanese Unexamined Patent Application Publication (JP-A) No. 2006-171077 (hereinafter, referred to as “Patent Document 2”) discloses a voice recognition device capable of, when voices such as guidance voices of car navigation are present in the background, removing the background sound and improving the clearness of the content of the user's utterance, to thereby perform more effective recognition. In Patent Document 2, the voice recognition device, in which the guidance voice signal is known, includes sound input means, voice recognition means, control means, storage means, and removing means. The storage means preliminarily registers the guidance voices and alarm sounds of car navigation. The control means transmits extracted signals to the storage means based on contents of external signals, which are the guidance voice signals and alarm sounds of car navigation. For a first recognition signal obtained from the voice recognition means and a second recognition signal obtained from the storage means, the removing means removes recognition candidates in which the contents of the two signals match from the first recognition signal, and produces the remaining recognition candidates, which are deemed the final recognition signals, as signals for controlling on-board devices.

Patent Document 2 discloses the method of removing the background voice signal by extracting and subtracting, from the input voice signal in which the user's utterance and the guidance voices as the background sounds are mixed, the guidance voice signal registered in the storage device. However, in Patent Document 2, real-time processing is impossible because synchronization is not established.

### DISCLOSURE OF THE INVENTION

### Problem to be Solved by the Invention

It is an exemplary object of this invention to provide a background noise cancelling device and method which are capable of removing, from an input signal, in real time with high accuracy a background noise which may be generated in common to terminals used in the same area (under the same exchange), such as announcements including an announcement over a building public address (PA) system, a public time signal, and a regular PA announcement.

### Means to Solve the Problem

A background noise cancelling device according to this invention is a background noise cancelling device for removing a background noise from an input signal in which the background noise is mixed in a voice signal to produce an output signal, including: storage means for storing a predictable background noise, which is the background noise, as a stored background noise in a state in which a synchronization signal is superimposed on the predictable background noise; estimation means for reading the stored background noise from the storage means and for correlating the read stored background noise and the input signal to establish synchronization by using the synchronization signal and to produce a predicted noise; and subtracting means for removing the predicted noise from the input signal to produce the voice signal obtained as a result of the removal.

A background noise cancelling method according to this invention is a background noise cancelling method of removing a background noise from an input signal in which the background noise is mixed in a voice signal to produce an output signal, including: a storage step of storing, in storage means, a predictable background noise, which is the background noise, as a stored background noise in a state in which a synchronization signal is superimposed on the predictable background noise; an estimation step of reading the stored background noise from the storage means and of correlating the read stored background noise and the input signal to establish synchronization by using the synchronization signal and to produce a predicted noise; and a removing step of removing the predicted noise from the input signal to produce the voice signal obtained as a result of the removing.

### Effect of the Invention

The background noise cancelling device according to this invention is capable of predicting and removing the background noise in real time with high accuracy by preliminarily storing the background noise that is heard in common in the same area, in a state in which the synchronization signal is superimposed on the background noise.

### BRIEF DESCRIPTION OF THE DRAWINGS

FIG. 1 is a schematic block diagram illustrating a communication system to which a background noise cancelling device according to a first exemplary embodiment of this invention is applied;

FIG. 2 is a block diagram illustrating the background noise cancelling device according to the first exemplary embodiment of this invention;

FIG. 3 is a schematic block diagram illustrating a communication system to which a background noise cancelling device according to a second exemplary embodiment of this invention is applied; and

FIG. 4 is a schematic block diagram illustrating a communication system to which a background noise cancelling device according to a third exemplary embodiment of this invention is applied.

### MODE FOR EMBODYING THE INVENTION

Hereinafter, exemplary embodiments of this invention are described in detail.

This invention is outlined.

For a signal input to an exchange, a sound (background noise) that is heard in common under the exchange is supplied to an announcement data storage unit. Then, an announcement estimator correlates the input signal and an announcement signal stored in the announcement data storage unit to calculate a predicted noise. Thereafter, a subtractor removes the predicted noise from the input signal. The output of the subtractor is also fed back to the announcement estimator to be used for amplitude adjustment of the predicted noise, for example.

By adding a pseudo noise to the background noise such as an announcement over a building public address (PA) system and a public time signal for reproduction, a synchronization signal is superimposed on the input signal input from the terminal and the signal stored in the announcement data storage unit, and hence the background noise may be synchronized in the announcement estimator and the subtractor. By being synchronized in time, the background noise may be removed in real time with high accuracy.

### Exemplary Embodiment 1

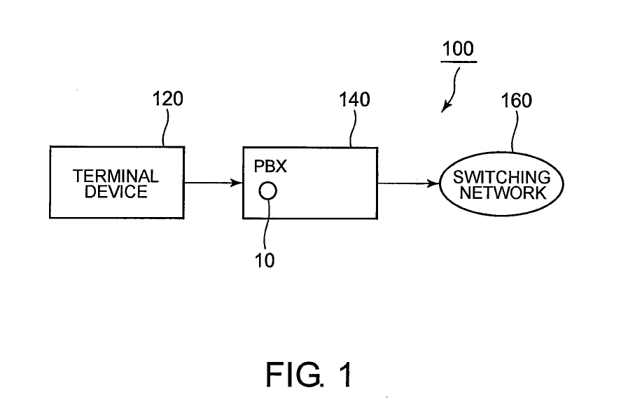

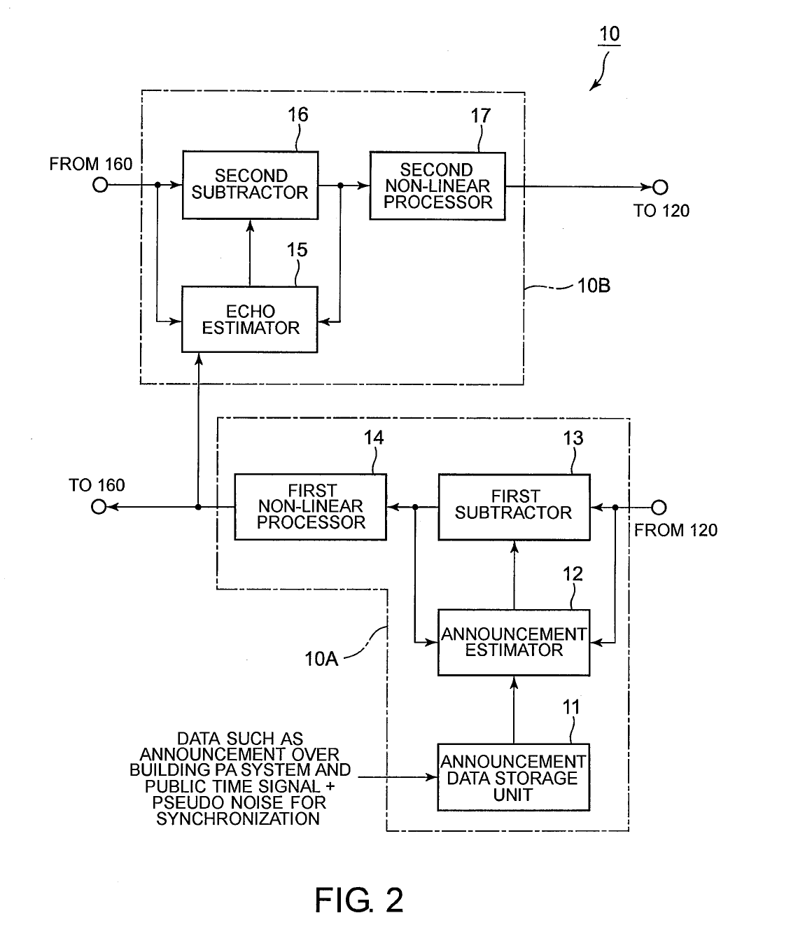

Referring to FIGS. 1 and 2, a background noise cancelling device according to a first exemplary embodiment of this invention is described. FIG. 1 is a schematic block diagram illustrating a communication system 100 to which the background noise cancelling device according to this invention is applied. FIG. 2 is a block diagram illustrating a background noise cancelling device 10 according to the first exemplary embodiment of this invention.

As illustrated in FIG. 1, the communication system 100 includes a terminal device 120, a private branch exchange (PBX) 140, and a switching network 160. Of background noises mixed in the terminal device 120, known background noises are removed in the PBX 140. The input signal from which the background noises are removed is passed to the switching network 160. For that purpose, the PBX 140 includes the background noise cancelling device 10 as illustrated in FIG. 2.

As illustrated in FIG. 2, the background noise cancelling device 10 includes a background noise canceller 10A for cancelling an uplink background noise, and an echo canceller 10B for cancelling a downlink echo.

The background noise canceller 10A includes an announcement data storage unit 11, an announcement estimator 12, a first subtractor 13, and a first non-linear processor 14.

As described above, the input signal from the terminal device 120 is supplied to the PBX 140 in a state in which a voice signal includes the background noise. Predictable background noises (announcements) such as the announcement over the building PA system, the public time signal, and a regular PA announcement are preliminarily supplied (stored) in the announcement data storage unit 11 as stored background noises. The announcement estimator 12 reads the background noise stored in the announcement data storage unit 11, and compares (correlates) the read background noise and the input signal from the terminal device 120 to calculate a predicted noise and to produce it. At this time, when the pseudo noise is superimposed on the background noise, it is possible to use a band pass filter (BPF) to synchronize in time the input signal and the signal from the announcement data storage unit 11.

To be specific, the pseudo noise is a noise generated in a pseudo manner, and hence the frequency band pattern thereof may be generated by oneself. Therefore, by supplying a certain pattern (pseudo noise) to a band that is to be used for synchronization and then extracting the pattern by the BPF, a synchronization signal may be extracted.

As described above, the predicted noise and the input signal are completely synchronized in time, and hence the first subtractor 13 may remove the predicted noise from the input signal without any time shift (in real time). The voice signal obtained as a result of the removal of the noise passes through the non-linear processor 14 to be output to the switching network 160 (FIG. 1).

That is, the background noise cancelling device (10) according to this exemplary embodiment is a background noise cancelling device (10) for removing a background noise from an input signal in which the background noise is mixed in a voice signal to produce an output signal, including: storage means (11) for preliminarily storing a predictable background noise, which is the background noise, as a stored background noise in a state in which a synchronization signal is superimposed on the predictable background noise; estimation means (12) for reading the stored background noise from the storage means (11) and for correlating the read stored background noise and the input signal to establish synchronization by using the synchronization signal and to produce a predicted noise; and subtracting means (13) for removing the predicted noise from the input signal to produce the voice signal obtained as a result of the removal.

Further, in the above-mentioned exemplary embodiment, the background noise cancelling device (10) further includes non-linear processing means (14) for performing non-linear processing on the voice signal obtained as the result of the removal to produce the output signal. The estimation means (12) adjusts an amplitude of the predicted noise based on the voice signal obtained as the result of the removal. The predictable background noise includes a sound that is heard in common in a specific area. The sound that is heard in common in the specific area includes at least one of an announcement over a building public address system, a public time signal, and a regular public address announcement. The synchronization signal includes a pseudo noise. The estimation means (12) allows the read stored background noise to pass through a band pass filter (BPF) to extract the pseudo noise and to establish the synchronization.

The input signal to the first subtractor 13 is a voice signal including the background noise from the terminal device 120, and some background noises, such as announcements heard in an area (for example, over a building PA system), may be predicted to a certain extent. Such predictable background noises (announcements) are supplied to the announcement data storage unit 11 and correlated by the announcement estimator 12 with the input signal from the terminal device 120 so that the background noise (predicted noise) is removed from the input signal by the first subtractor 13. Further, the voice signal which is obtained as the result of the removal and which is produced from the first subtractor 13 is fed back to the announcement estimator 12 to be used in analyzing the noise components included in the input signal.

In contrast to the echo, the input background noise is easily predicted, and hence the first subtractor 13 may remove the background noise (predicted noise) in real time with high accuracy.

On the other hand, the echo canceller 10B is constituted by a normal echo canceller. Specifically, the echo canceller 10B includes an echo estimator 15, a second subtractor 16, and a second non-linear processor 17.

There is no difference between the operation of the second subtractor 16 and the second non-linear processor 17 and the operation of the first subtractor 13 and the first non-linear processor 14. The operating principles of the echo estimator 15 and the announcement estimator 12 are substantially the same, and the difference in a case where there is no pseudo noise is the source of the input signal.

In contrast to the echo estimator 15, when there is a pseudo noise, the announcement estimator 12 additionally performs an operation of subjecting both the background noise stored in the announcement data storage unit 11 and the input signal to the band pass filter (BPF) for alignment of time axis.

Next, an effect of the first exemplary embodiment of this invention is described.

The effect of the first exemplary embodiment is that the predictable background noise may be removed from the input signal in real time with high accuracy. This is accomplished because the announcement data storage unit 11 preliminarily stores the background noise (predictable background noise) that is heard in common in a specific area, in a state in which the synchronization signal such as the pseudo noise is superimposed on the background noise, and the announcement estimator 12 correlates the input signal and the background noise read from the announcement data storage unit 11 to establish synchronization based on the above-mentioned synchronization signal and to produce the predicted noise.

Note that, this invention is not limited to the first exemplary embodiment described above, and may be embodied by providing, in a case of an internet protocol (IP) network, for example, a similar mechanism that operates on the IP to a media gateway (MGW) device and a terminal device.

Further, in a case of a background noise that is generated nationally, the scale can be enlarged easily by preliminarily inputting (storing) the same background noise information in a plurality of exchanges.

### Exemplary Embodiment 2

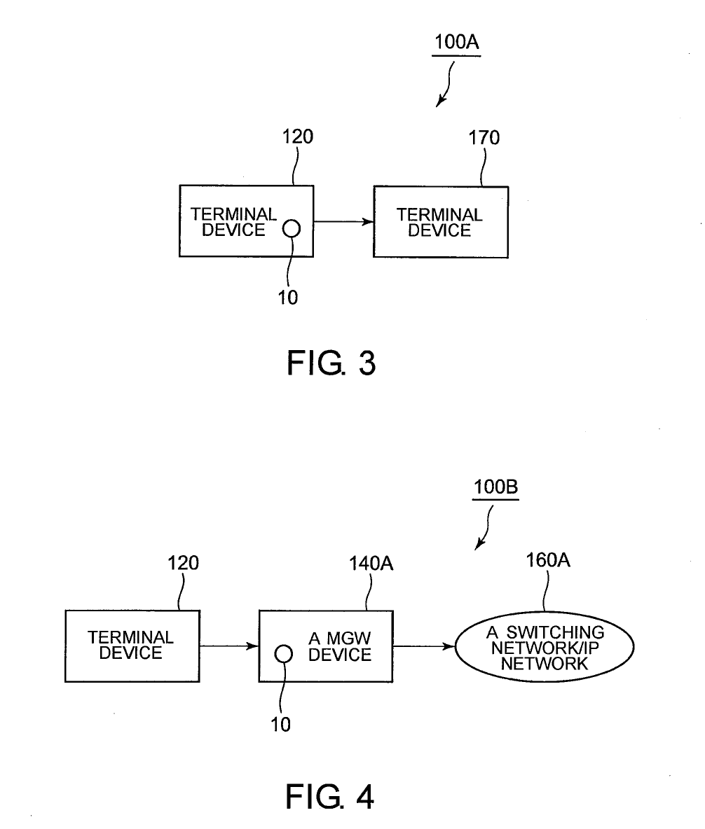

Referring to FIG. 3, a communication system 100A to which a background noise cancelling device according to a second exemplary embodiment of this invention is applied is described.

The illustrated communication system 100A includes a first terminal device 120 and a second terminal device 170, which are connected by a communication line.

In the communication system 100A, the terminal devices 120 and 170 directly communicate with each other, and hence the operation of removing the background noise needs to be performed by the terminal devices.

Therefore, the first terminal device 120 includes the background noise cancelling device 10 illustrated in FIG. 2.

### Exemplary Embodiment 3

Referring to FIG. 4, a communication system 100B to which a background noise cancelling device according to a third exemplary embodiment of this invention is applied is described.

The illustrated communication system 100B includes a terminal device 120, an MGW device 140A, and a switching network/IP network 160.

The MGW device 140A is a device for performing voice processing, and performs codec (such as G.711, AMR, EVR) conversion, echo removal, and volume control, for example. In many cases, the MGW device 140A also includes an interface to a switching network and an IP network to perform interface conversion.

Known background noises of the background noises mixed in the terminal device 120 are removed by the MGW device 140A. The input signal from which the background noises are removed is passed to the switching network/IP network 160A. For that purpose, the MGW device 140A includes the background noise cancelling device 10 as illustrated in FIG. 2.

In contrast to the PBX 140, which is installed within the premises, the MGW device 140A is located on a public network and hence capable of removing a wider range of background noises.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

The whole or part of the exemplary embodiments disclosed above can be described as, but not limited to, the following supplementary notes.

(Supplementary note 1) A background noise cancelling device for removing a background noise from an input signal in which the background noise is mixed in a voice signal to produce an output signal, including:

storage means for preliminarily storing a predictable background noise, which is the background noise, as a stored background noise in a state in which a synchronization signal is superimposed on the predictable background noise;

estimation means for reading the stored background noise from the storage means and for correlating the read stored background noise and the input signal to establish synchronization by using the synchronization signal and to produce a predicted noise; and

subtracting means for removing the predicted noise from the input signal to produce the voice signal obtained as a result of the removal.

(Supplementary note 2) A background noise cancelling device according to Supplementary note 1, further including non-linear processing means for performing non-linear processing on the voice signal obtained as the result of the removal to produce the output signal.

(Supplementary note 3) A background noise cancelling device according to Supplementary notes 1 or 2, in which the estimation means adjusts an amplitude of the predicted noise based on the voice signal obtained as the result of the removal.

(Supplementary note 4) A background noise cancelling device according to any one of Supplementary notes 1 to 3, in which the predictable background noise includes a sound that is heard in common in a specific area.

(Supplementary note 5) A background noise cancelling device according to Supplementary note 4, in which the sound that is heard in common in the specific area includes at least one of an announcement over a building public address system, a public time signal, and a regular public address announcement.

(Supplementary note 6) A background noise cancelling device according to any one of Notes 1 to 5, in which the signal for synchronization includes a pseudo noise.

(Supplementary note 7) A background noise cancelling device according to Supplementary note 6, in which the estimation means allows the read stored background noise to pass through a band pass filter to extract the pseudo noise and to establish the synchronization.

(Supplementary note 8) A background noise cancelling device according to any one of Supplementary notes 1 to 7, further including an echo canceller.

(Supplementary note 9) A private branch exchange, including the background noise cancelling device according to any one of Supplementary notes 1 to 8.

(Supplementary note 10) A terminal device, including the background noise cancelling device according to any one of Supplementary notes 1 to 8.

(Supplementary note 11) An MGW device, including the background noise cancelling device according to any one of Supplementary notes 1 to 8.

(Supplementary Note 12) A background noise cancelling method of removing a background noise from an input signal in which the background noise is mixed in a voice signal to produce an output signal, including:

a storage step of preliminarily storing, in storage means, a predictable background noise, which is the background noise, as a stored background noise in a state in which a synchronization signal is superimposed on the predictable background noise;

an estimation step of reading the stored background noise from the storage means and of correlating the read stored background noise and the input signal to establish synchronization by using the synchronization signal and to produce a predicted noise; and

a removing step of removing the predicted noise from the input signal to produce the voice signal obtained as a result of the removing.

(Supplementary note 13) A background noise cancelling method according to Supplementary note 12, further including a step of performing non-linear processing on the voice signal obtained as the result of the removing to produce the output signal.

(Supplementary note 14) A background noise cancelling method according to Supplementary note 12 or 13, in which the estimation step includes adjusting an amplitude of the predicted noise based on the voice signal obtained as the result of the removing.

(Supplementary note 15) A background noise cancelling method according to any one of Supplementary notes 12 to 14, in which the predictable background noise includes a sound that is heard in common in a specific area.

(Supplementary note 16) A background noise cancelling method according to Supplementary note 15, in which the sound that is heard in common in the specific area includes at least one of an announcement over a building public address system, a public time signal, and a regular public address announcement.

(Supplementary note 17) A background noise cancelling method according to any one of Supplementary notes 12 to 16, in which the synchronization signal includes a pseudo noise.

(Supplementary note 18) A background noise cancelling method according to Supplementary note 17, in which the estimation step includes allowing the read stored background noise to pass through a band pass filter to extract the pseudo noise and to establish the synchronization.

### INDUSTRIAL APPLICABILITY

This invention may be applied to manual processing performed on the network side on a sound that is heard in common in a specific area (such as an announcement over the building PA system, a public time signal, and a regular PA announcement).

This application is based on and claims the benefit of priority from Japanese Patent Application No. 2010-091864, filed on Apr. 13, 2010, the disclosure of which is incorporated herein in its entirety by reference.

### REFERENCE SIGNS LIST

10 . . . background noise cancelling device
10A . . . background noise canceller
10B . . . echo canceller
11 . . . announcement data storage unit
12 . . . announcement estimator
13 . . . first subtractor
14 . . . first non-linear processor
15 . . . echo estimator
16 . . . second subtractor
17 . . . second non-linear processor
100, 100A, 100B . . . communication system
120, 170 . . . terminal device
140 . . . private branch exchange (PBX)
140A . . . MGW device
160 . . . switching network
160A . . . switching network/IP network

1. A background noise cancelling device for removing a background noise from an input signal in which the background noise is mixed in a voice signal to produce an output signal, comprising:
for a storage unit that preliminarily stores a predictable background noise, which is the background noise, as a stored background noise in a state in which a synchronization signal is superimposed on the predictable background noise;
an estimator that reads the stored background noise from the storage means and that correlates the read stored background noise and the input signal to establish synchronization by using the synchronization signal and to produce a predicted noise; and
a subtractor that removes the predicted noise from the input signal to produce the voice signal obtained as a result of the removal.

2. A background noise cancelling device according to claim 1, further comprising a non-linear processor that performs non-linear processing on the voice signal obtained as the result of the removal to produce the output signal.

3. A background noise cancelling device according to claim 1, wherein the estimator adjusts an amplitude of the predicted noise based on the voice signal obtained as the result of the removal.

4. A background noise cancelling device according to claim 1, wherein the predictable background noise comprises a sound that is heard in common in a specific area.

5. A background noise cancelling device according to claim 4, wherein the sound that is heard in common in the specific area comprises at least one of an announcement over a building public address system, a public time signal, and a regular public address announcement.

6. A background noise cancelling device according to claim 1, wherein the synchronization signal comprises a pseudo noise.

7. A background noise cancelling device according to claim 6, wherein the estimator allows the read stored background noise to pass through a band pass filter to extract the pseudo noise and to establish the synchronization.

8. A background noise cancelling device according to claim 1, further comprising an echo canceller.

9. A private branch exchange, comprising the background noise cancelling device according to claim 1.

10. A terminal device, comprising the background noise cancelling device according to claim 1.

11. An MGW device, comprising the background noise cancelling device according to claim 1.

12. A background noise cancelling method of removing a background noise from an input signal in which the background noise is mixed in a voice signal to produce an output signal, comprising:
preliminarily storing, in a storage unit, a predictable background noise, which is the background noise, as a stored background noise in a state in which a synchronization signal is superimposed on the predictable background noise;
reading the stored background noise from the storage unit and correlating the read stored background noise and the input signal to establish synchronization by using the synchronization signal and to produce a predicted noise; and
removing the predicted noise from the input signal to produce the voice signal obtained as a result of the removing.

13. A background noise cancelling method according to claim 12, further comprising performing non-linear processing on the voice signal obtained as the result of the removing to produce the output signal.

14. A background noise cancelling method according to claim 12, wherein the reading and correlating comprises adjusting an amplitude of the predicted noise based on the voice signal obtained as the result of the removing.

15. A background noise cancelling method according to claim 12, wherein the predictable background noise comprises a sound that is heard in common in a specific area.

16. A background noise cancelling method according to claim 15, wherein the sound that is heard in common in the specific area comprises at least one of an announcement over a building public address system, a public time signal, and a regular public address announcement.

17. A background noise cancelling method according to claim 12, wherein the synchronization signal comprises a pseudo noise.

18. A background noise cancelling method according to claim 17, wherein the reading and correlating comprises allowing the read stored background noise to pass through a band pass filter to extract the pseudo noise and to establish the synchronization.

19. A background noise cancelling device according to claim 2, wherein the estimation means estimator adjusts an amplitude of the predicted noise based on the voice signal obtained as the result of the removal.

20. A background noise cancelling device according to claim 2, wherein the predictable background noise comprises a sound that is heard in common in a specific area.
